(19) United States
(12) Patent Application Publication
(10) Pub. No.: US 2025/0322401 A1
(43) Pub. Date: Oct. 16, 2025

(54) AUTHORIZATION LAYER FOR CONTROLLING RESOURCE TRANSFERS

(71) Applicant: Truist Bank, Charlotte, NC (US)

(72) Inventor: Prasad P. Jahagirdar, Charlotte, NC (US)

(73) Assignee: Truist Bank, Charlotte, NC (US)

(21) Appl. No.: 18/634,195

(22) Filed: Apr. 12, 2024

Related U.S. Application Data
(63) Continuation of application No. 18/633,621, filed on Apr. 12, 2024.

(51) Int. Cl. G06Q 20/40; G06Q 20/06

(52) U.S. Cl. CPC G06Q 20/4016; G06Q 20/0655; G06Q 20/4014

(57) ABSTRACT

A system can be provided for controlling resource transfers based on user approval status. For example, the system receiving user data. The user data can include users associated with an entity and at least one approval status for each of the users. The at least one approval status of each user can be selected from a group consisting of approver administrator, approver non-administrator, and non-approver non-administrator. The system can further generate a graphical user interface based on the user data. The graphical user interface can include user listings and corresponding approval status identifiers. Each user listing can correspond to one of the users and the corresponding approval status identifiers can indicate the at least one approval status of each user.

### CROSS-REFERENCE TO RELATED APPLICATIONS

This application is a continuation of U.S. patent application Ser. No. 18/633,621, filed Apr. 12, 2024, and titled “AUTHORIZATION LAYER FOR CONTROLLING RESOURCE TRANSFERS,” the entirety of which is incorporated herein by reference.

### TECHNICAL FIELD

The present disclosure relates generally to secure resource transfers and, more particularly (although not necessarily exclusively), to implementing an authorization layer to control resource transfers.

### BACKGROUND

Resource systems may facilitate transfers of resources. Examples of the resource systems may include mobile banking applications, Automated Clearing House, online payment services (e.g., Zelle), peer-to-peer payment systems (e.g., Apple Pay), wire transfer channels, or the like. In some examples, the resource systems can be used for performing data (e.g., electronic fund) transfers between user accounts associated with one or more entities (e.g., financial institutions). Additionally, user profiles can be associated with the user accounts, and users can be authenticated based on information in the user profiles. For example, authentication with a user account can enable a user (e.g., an external client of the entity) to monitor data transfers performed via one or more resources systems with respect to the user account, initiate the data transfers, or perform other suitable operations.

### SUMMARY

According to one example of the present disclosure, a system can include a processor and a memory including instructions that are executable by the processor to perform operations. The operations can include receiving user data, the user data comprising a plurality of users associated with an entity and at least one approval status for each user of the plurality of users, wherein the at least one approval status of each user of the plurality of users is selected from a group consisting of approver administrator, approver non-administrator, and non-approver non-administrator. The operations can also include generating a graphical user interface based on the user data, wherein the graphical user interface comprises a plurality of user listings and corresponding approval status identifiers, wherein each user listing of the plurality of user listings corresponds to a user of the plurality of users, and wherein the corresponding approval status identifiers indicate the at least one approval status of each user of the plurality of users.

According to another example of the present disclosure, a non-transitory computer readable medium may contain instructions that are executable by a processor to cause the processor to perform operations. The operations can include receiving user data, the user data comprising a plurality of users associated with an entity and at least one approval status for each user of the plurality of users, wherein the at least one approval status of each user of the plurality of users is selected from a group consisting of approver administrator, approver non-administrator, and non-approver non-administrator. The operations can also include generating a graphical user interface based on the user data, wherein the graphical user interface comprises a plurality of user listings and corresponding approval status identifiers, wherein each user listing of the plurality of user listings corresponds to a user of the plurality of users, and wherein the corresponding approval status identifiers indicate the at least one approval status of each user of the plurality of users.

According to a further example of the present disclosure, a computer-implemented method can involve receiving user data, the user data comprising a plurality of users associated with an entity and at least one approval status for each user of the plurality of users, wherein the at least one approval status of each user of the plurality of users is selected from a group consisting of approver administrator, approver non-administrator, and non-approver non-administrator. The method can also involve generating a graphical user interface based on the user data, wherein the graphical user interface comprises a plurality of user listings and corresponding approval status identifiers, wherein each user listing of the plurality of user listings corresponds to a user of the plurality of users, and wherein the corresponding approval status identifiers indicate the at least one approval status of each user of the plurality of users.

### BRIEF DESCRIPTION OF THE DRAWINGS

FIG. 1 is a block diagram of an example of a computing environment for implementing an authorization layer to control resource transfers according to some embodiments of the present disclosure.

FIG. 2 depicts an example of a graphical user interface for controlling user approval status according to some embodiments of the present disclosure.

FIG. 3 is a block diagram of an example of a computing device for implementing an authorization layer to control resource transfers according to some embodiments of the present disclosure.

FIG. 4 is a flowchart of an example of a process implementing an authorization layer to control resource transfers according to some embodiments of the present disclosure.

### DETAILED DESCRIPTION

Certain aspects and examples of the present disclosure relate to controlling resource transfers based on user approval status. In one aspect, a system can receive a request to transfer a resource from a user device, and can perform the transfer based on an approval status of a user associated with the user device. For example, based on the approval status of the user, the system may automatically transfer the resource, may deny the request to transfer the resource, or may delay the transfer until receiving an approval indicator for the request. In another aspect, the system can generate a graphical user interface (GUI) through which approval statuses of users can be assigned and updated to control user access to a user account.

The approval statuses can correlate with privilege levels (e.g., administrative rights or access restrictions) of users with respect to the user account. For example, a user with an approval status of “approver administrator” can initiate resource transfers to or from the user account and can approve resource transfers initiated by other users. A user with an approval status of “approver non-administrator” may also be able to approve resource transfers initiated by other users. But, the user with the approval status of approver non-administrator may transmit requests for resource transfers to or from the user account rather than being able to initiate the resource transfers. Additionally, a user with an approval status of “non-approver non-administrator” may be able to transmit requests for resource transfers to or from the user account. But, a user with an approval status of non-approver non-administrator may not be able to approve resource transfers initiated by other users.

In some examples, users may be able to perform actions (e.g., initiate resource transfers) with respect to a user account associated with the entity. Enabling the actions to be performed by several users can render the user account vulnerable to security breaches or inaccurate data transfers, which can result in loss of data, unauthorized data usage, and a reduction in data integrity. The security breaches or inaccurate data transfers may then cause in latency for systems which facilitate resource (e.g., data) transfers and maintenance (e.g., resource systems). For example, a user may initiate a resource transfer via a user device for an incorrect type or amount of the resource. To counteract the inaccurate resource transfer, a resource system (e.g., the system through which the resource was transferred) may perform a resource transfer reversal in an attempt to return the data to the user account. The resource transfer reversal may disrupt normal operations of the resource system, thereby increasing latency for the resource system.

Examples of the present disclosure can overcome one or more of the above-mentioned problems via the system that can control resource transfers based on user approval status. For example, upon receiving a request to transfer a resource from a user device associated with a user of approver administrator status, the system can automatically perform the resource transfer. Alternatively, upon receiving a request to transfer a resource from a user device associated with a user of approver non-administrator or non-approver non-administrator status, the system can delay the resource transfer until receiving an approval indicator from another user device associated with another user of approver administrator or approver non-administrator status. The approval indicator can provide approval of the request or approval of a modified version of the request. Thus, the system can implement an additional layer of authorization for some users before performing resource transfers with respect to a user account. As a result, unauthorized requests can be prevented (e.g., denied) or inaccurate requests can be corrected (e.g., modified), which can minimize or prevent the loss of data, unauthorized data usage, and the reduction in data integrity. Additionally, by preventing unauthorized or inaccurate requests from being transmitted to or processed at resource systems, the resource transfer reversals may not be performed, which can reduce latency for the resource systems.

The system can further transmit an alert to request the approval indicator from the user device associated with the user of the approver administrator or approval non-administrator status. In some examples, if a time between receiving the request to transfer the resource and receiving the approval indicator is greater than a threshold, the system can automatically transmit the alert. Additionally, if the time between receiving the request and receiving the approval indicator is greater than the threshold more than once, the system can transmit a notification to one or more user devices associated with users of approver administrator status. The notification may include a suggestion. For example, the notification may suggest that more users be provided approver non-administrator status via the GUI. In this way, the system can facilitate efficient resource transfer execution by resource systems when implementing the additional layer of authorization.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

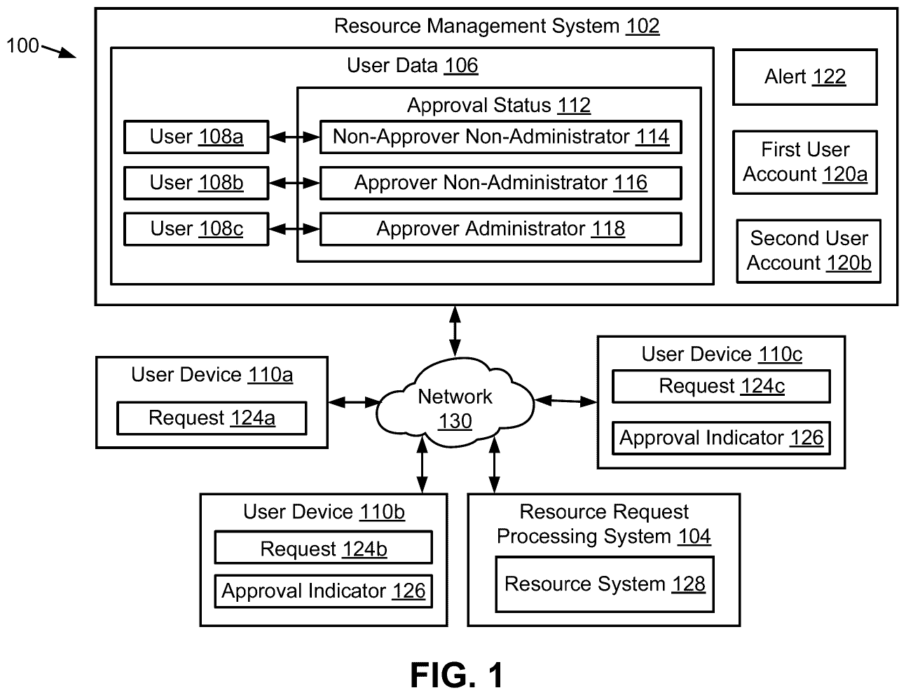

FIG. 1 is a block diagram of an example of a computing environment 100 for implementing an authorization layer to control resource transfers according to some embodiments of the present disclosure. The computing environment 100 can include a resource management system 102, which can be in communication with one or more user devices 110a-c and a resource request processing system 104 via a network 130. Examples of the network 130 can include a local area network (LAN) or the Internet.

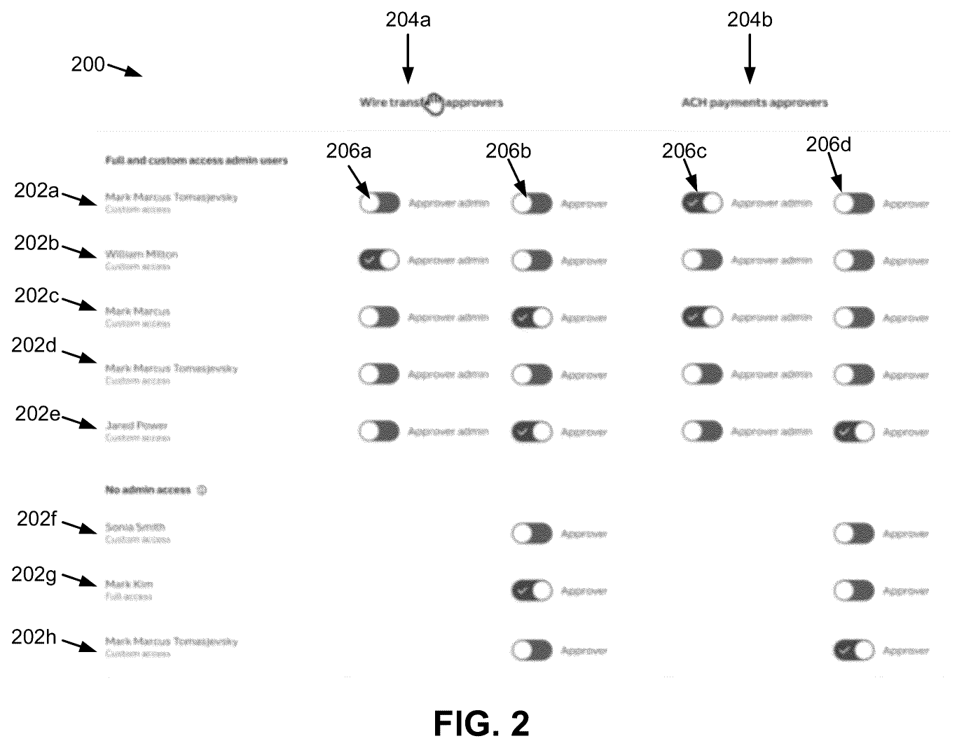

In some examples, the computing environment 100 may be a distributed computing environment, such as a cloud computing system, an IoT computing platform, or a computing cluster, formed from one or more nodes (e.g., physical or virtual servers) that are in communication with one another via a network 130. Additionally, in some examples, the computing environment 100 can be formed from a physical infrastructure that includes various network hardware, such as routers, hubs, bridges, switches, and firewalls. The physical infrastructure can also include one or more servers. The servers may provide backend support for a software application (e.g., a mobile application) or a web interface for enabling users 108a-c to control approval statuses, to transmit requests the resource management system 102, or a combination thereof. The software application or web interface can include a graphical user interface through which the users 108a-c can control approval statuses. An example of the graphical user interface is described below with respect to FIG. 2.

In an example, a first user account 120a associated with an entity can be established. The first user account 120a may be of any suitable type of account. For example, the entity may be a company and the first user account 120a may be a company bank account. Separately from establishing the first user account 120a, the users 108a-c associated with the entity can be provided access to the first user account 120a. For example, the users 108a-c may register user devices 110a-c with the first user account 120a to enable the users 108a-c to authenticate with, monitor, or perform actions with respect to the first user account 120a. Examples of the user devices 110a-c can include mobile phones, laptops, tablets, smart watches, etc.

As a result of registering the user devices 110a-c, the users 108a-c may obtain access to the first user account 120a via the software application or web interface. Upon receiving access to the first user account 120a, the users 108a-c can initiate resource (e.g., data, funds, or the like) transfers, which may be transmitted from the first user account 120a to another user account via a resource system 128 (e.g., Automated Clearing House (ACH), wire transfer, or the like). When a resource transfer is initiated, a resource management system 102 can receive a request to transfer the resource from a user device, and can determine whether to request additional approval before forwarding the request to the resource request processing system 104. In doing so, the resource management system 102 can improve a security and accuracy of resource transfers performed with respect to the first user account 120a.

For example, the resource management system 102 can store user data 106 in, for example, a database. The user data 106 can include the users 108a-c associated with the entity. In a particular example, the entity can be a company and the users can be employees of the company. The user data 106 can further include an approval status 112 for each of the users 108a-c. The approval status 112 for each user can be approver administrator 118, approver non-administrator 116, and non-approver non-administrator 114. In the particular example, a first user 108a can have an approval status 112 of non-approver non-administrator 114, a second user 108b can have an approval status 112 of approver non-administrator 116, and a third user 108c can have an approval status 112 of approver administrator 118.

In some examples, the approval status 112 can correlate with a privilege level of each of the users 108a-c with respect to the user account 120a. That is, each of the users 108a-c may be able to perform actions (e.g., initiate resource transfers to or from the first user account 120a) or to approve performance of actions at the user account 120a based on their approval status. For example, approver administrator 118 can be associated with a highest privilege level. A user with an approval status 112 of approver administrator 118 may be able to initiate resource transfers to or from the user account 120a and approve resource transfers to or from the user account 120a initiated by other users. Similarly, a user with an approval status 112 of approver non-administrator 116 may be able to approve resource transfers initiated by other users. Additionally, a user with an approval status 112 of approver non-administrator 116 may be able to transmit requests for resource transfers to or from the user account 120a, which may be approved by another user of approver administrator or approver non-administrator status. A user with an approval status 112 of non-approver non-administrator 114 may also be able to transmit requests for resource transfers to or from the user account 120a. But, a user with an approval status 112 of non-approver non-administrator 114 may not be able to approve resource transfers initiated by other users.

In the particular example, the resource management system 102 can receive a first request 124a to transfer a resource (e.g., data, funds, or another suitable resource) from the first user account 120a to a second user account 120b. The first request 124a can be received from a first user device 110a associated with the first user 108a. The resource management system 102 can then access the user data 106 in the database and analyze the user data 106 to determine that an approval status 112 of the first user 108a is non-approver non-administrator 114.

In response to determining that the approval status 112 of the user is non-approval non-administrator 114, the resource management system 102 can transmit an alert 122 to user devices associated with a first subset of users with an approval status 112 of approver non-administrator 116. For example, the resource management system 102 can transmit the alert 122 to a second user device 110b associated with the second user 108b. The resource management system 102 can also transmit the alert 122 to user devices associated with a second subset of users with an approval status 112 of approver administrator 118. For example, the resource management system 102 can transmit the alert 122 to a third user device 110c associated with the third user 108c. Although three user devices are shown, the resource management system 102 can transmit alerts and receive requests from any number of user devices associated with any number of users.

The resource management system 102 may then receive an approval indicator 126 from the second user device 110b, the third user device 110c, or a combination thereof. In the particular example, the alert 122 can be a push notification, email, instant or text message, or other suitable alert type transmitted to the user devices 110b-c. The alert 122 may include an approve option, a deny option, a modication option, or a combination thereof. The users 108b-c of the user devices 110b-c can select the approve, deny, or modify option to cause the user device to transmit the approval indicator 126 or a denial indicator to the resource management system 102.

Upon receiving the approval indicator 126, the resource management system 102 can automatically transfer the resource from the first user account 120a to the second user account 120b. To do so, the resource management system 102 may include or be communicatively coupled with the resource request processing system 104. Thus, the resource management system 102 can forward the first request 124a to the resource request processing system 104. The resource request processing system 104 can include the resource system 128. The resource system 128 can be the part of the resource request processing system 104 through which the transfer of the resource from the first user account 120a to the second user account 120b can be performed. For example, the resource system 128 can be automated clearing house or the like. Thus, the resource management system 102 can transfer the resource between the accounts 120a-b via the resource system 128.

In another example, the resource management system 102 can receive a second request 124b to transfer a resource from the first user account 120a to the second user account 120b. The second request 124b can be received from the second user device 110b associated with the second user 108b. The resource management system 102 can then determine, based on the user data 106, that an approval status 112 of the second user 108b is approver non-administrator 116.

In response to determining that the approval status 112 of the user is approver non-administrator 116, the resource management system 102 can transmit the alert 122 to the user devices associated with the second subset of users with the approval status 112 of approver administrator 118. For example, the resource management system 102 can transmit the alert 122 to the third user device 110c associated with the third user 108c. In some examples, the resource management system 102 can also transmit the alert 122 to the user devices associated with the first subset of users with the approval status 112 of approver non-administrator 116. In such examples, the user devices may exclude the second user device 110b from which the second request 124b was received.

The resource management system 102 may then receive an approval indicator 126 from the third user device 110c. In some examples, the approval indicator 126 can include a modification to the resource to be transferred from the first user account 120a to the second user account 120b. The modification can be a modification to a type or amount of the resource being transferred. For example, the second request 124b may be a request to transfer five hundred dollars from the first user account 120a to the second user account 120b. Upon receiving the alert 122, the second user 108b may use the modification option to modify the request. In particular, the second user 108b may input a different amount of funds to be transferred (e.g., four hundred dollars). Due to the second user 108b inputting the different amount of funds, the different amount of funds can be included in the approval indicator 126 transmitting by the third user device 110c.

Upon receiving the approval indicator 126, the resource management system 102 can automatically transfer the resource from the first user account 120a to the second user account 120b via the resource system 128. The resource management system 102 can transfer the resource according to the modification included in the approval indicator 126.

In some examples, the resource management system 102 can determine a duration of time between receiving the request 124b and receiving the approval indicator 126. The resource management system 102 may compare the duration of time to a threshold (e.g., one hour, three hours, twenty-four hours). After the duration of time, the resource management system 102 may automatically transmit another alert 122 to the user devices associated with the second subset of users. Additionally or alternatively, the system can transmit a notification the user devices associated with the second subset of users. The notification may include a suggestion for improving an efficiency of request approval. For example, the notification may suggest that more users be provided approver non-administrator status via the GUI (e.g., GUI 200 depicted in FIG. 2).

In a further example, the resource management system 102 can receive a third request 124c to transfer a resource from the first user account 120a to the second user account 120b. The third request 124c can be received from the third user device 110c associated with the third user 108c. The resource management system 102 can then determine, based on the user data 106, that an approval status 112 of the third user 108c is approver administrator 118. Due to the approval status 112 being approver administrator 118, the resource management system 102 can automatically transfer the resource from the first user account 120a to the second user account 120b via the resource system 128.

FIG. 2 depicts an example of a graphical user interface (GUI) 200 for controlling user approval status according to some embodiments of the present disclosure. The GUI 200 can include user listings 202a-h, which can each correspond to a user associated with an entity. The GUI 200 can further include approval status identifiers that correspond with each of the user listings 202a-h. In some examples, there can be approval status identifiers for each resource system that may be used to transfer resources to or from a user account associated with the entity. For example, a first resource system associated with a first resource system option 204a can involve using wire transfers to transfer resources to or from the user account and a second resource system associated with a second resource system option 204b can involve using automated clearing house (ACH).

An approval status of each user can be assigned using the approval status identifiers corresponding to each user listing. Additionally, an approval status for each user with respect to each resource system option 204a-b can be assigned. As depicted, toggling an approval status identifier to the left can indicate that the user does not have corresponding privileges (e.g., ability to approve resource transfer requests associated with a resource system). In contrast, toggling an approval status indicator to the right can indicate the user does have the corresponding privileges.

For example, a first approver status indicator 206a and a second approver status indicator 206b can be associated with the first resource system option 204a and can correspond with a first user listing 202a. Additionally, a third approver status indicator 206c and a fourth approver status indicator 206d can be associated with the second resource system option 204b and can correspond with the first user listing 202a. The first approver status indicator 206a and the third approver status indicator 206c can be associated with an approver status of approver administrator for each of the resource systems. The second approver status indicator 206b and the fourth approver status indicator 206d can be associated with an approval status of approver non-administrator for each of the resource systems. As depicted, the first approver status indicator 206a, the second approver status indicator 206b, and the fourth approver status indicator 206d can be toggled to the left, while the third approver status indicator 206c can be toggled to the right. Thus, a first user corresponding the first user listing 202a can have an approval status of approver administrator for the second resource system. As a result, the first user may be able to, for example, use a user to device to initiate a resource transfer via the second resource system 204b. To initiate the resource transfer, the user device may interact with a resource management system, such as the resource management system 102 depicted in FIG. 1.

In some examples, the resource management system 102 can generate and monitor the GUI 200. In doing so, the resource management system 102 can generate and update user data, such as user data 106 depicted in FIG. 1, based on the user listings 202a-h and approval status identifiers of the GUI 200. For example, the user data 106 can include each user and corresponding approval statuses of each user for each resource system. The users and corresponding approval statuses can correspond to user listings 202a-h and settings (e.g., toggle direction) of each approval status identifier for each user listing.

Additionally, in some examples, approval status identifiers can be updated. For example, an approval status identifier of “approver” can be selected (e.g., toggled from left to right) by a user of a user device on which the GUI 200 is displayed. As a result, an approval status of a user corresponding to the approver status identifier can be updated. The resource management system 102 can detect and record the update to the approval status based on the user selection of the approval status identifier. The resource management system 102 can further update the user data 106 accordingly. For example, the resource management system 102 may change the approval status of the user corresponding to the approval status identifier from non-approver non-administrator to approver non-administrator.

Moreover, in some examples, when generating the GUI 200, the resource management system 102 may load a first set of user listings and corresponding approver status identifiers. Then, as the resource management system 102 detects a user scrolling through the user listings at the GUI 200, the resource management system 102 may load a second set of user listings and corresponding approval status identifiers. Thus, the resource management system 102 can load the first subset of user listings and corresponding approval status identifiers at a first time and load the second subset of user listings and corresponding approval status identifiers at a second time. In doing so, the GUI 200 can be generated in an efficient manner. In some examples, the GUI 200 can include a setting through which a user can select a number (e.g., 10, 20, or 50) of user listings for the resource management system 102 to load at a time.

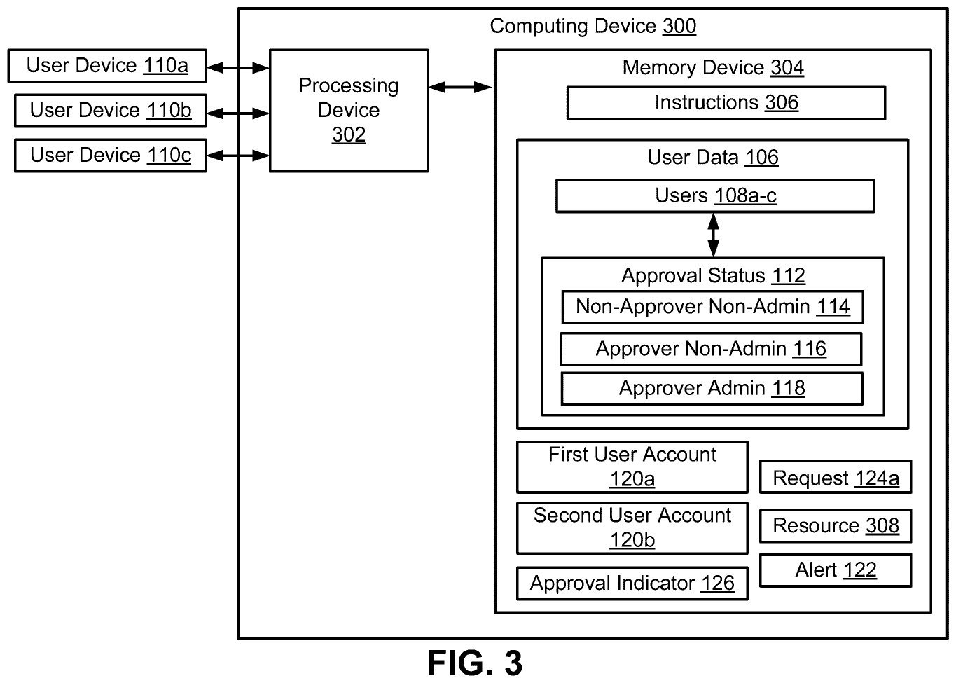

FIG. 3 is a block diagram of an example of a computing device 300 for implementing an authorization layer to control resource transfers according to some embodiments of the present disclosure. As depicted, the computing device 300 may include a processing device 302 communicatively coupled to a memory device 304. In some examples, the components shown in FIG. 3 can be integrated into a single structure. For example, the components can be within a single housing. In other examples, the components shown in FIG. 3 can be distributed (e.g., in separate housings) and in electrical communication with each other.

The processing device 302 can execute one or more operations for implementing some examples. The processing device 302 can execute instructions 306 stored in the memory device 304 to perform the operations. The processing device 302 can include one processing device or multiple processing devices. Non-limiting examples of the processing device 302 include a Field-Programmable Gate Array (“FPGA”), an application-specific integrated circuit (“ASIC”), a microprocessor, etc. In some examples, the instructions 306 can include processor-specific instructions generated by a compiler or an interpreter from code written in any suitable computer-programming language, such as C, C++, C#, Python, or Java.

The memory device 304 can include one memory or multiple memories. The memory device 304 can be non-volatile and may include any type of memory that retains stored information when powered off. Non-limiting examples of the memory device 304 include electrically erasable and programmable read-only memory (EEPROM), flash memory, or any other type of non-volatile memory. At least some of the memory device 304 can be a non-transitory, computer-readable medium from which the processing device 302 can read the instructions 306. A computer-readable medium can include electronic, optical, magnetic, or other storage devices capable of providing the processing device 302 with computer-readable instructions or other program code. Non-limiting examples of a computer-readable medium include magnetic disk(s), memory chip(s), ROM, random-access memory (RAM), an ASIC, a configured processor, optical storage, or any other medium from which the processing device 302 can read the instructions 306.

The processing device 302 can execute the instructions 306 to perform operations. For example, the processing device 302 can store user data 106. The user data can include a plurality of users 108a-c associated with an entity and an approval status 112 for each of the plurality of users 108a-c. The approval status 112 of each of the users 108a-c can be selected from a group consisting of approver administrator 118, approver non-administrator 116, and non-approver non-administrator 114. The processing device 302 can further receive, from a user device 110a associated with one of the users (e.g., user 108a), a request 124a to transfer a resource 308 from a first user account 120a associated with the entity to a second user account 120b. The processing device 302 can also determine, based on the user data 106, that an approval status 112 of the user 108a is non-approver non-administrator 114. In response to determining that the approval status 112 of the user 108a is non-approver non-administrator 114, the processing device 202 can transmit an alert 122 to a first plurality of user devices (e.g., user device 110b) associated with a first subset of the plurality of users (e.g., user 108b) with an approval status 112 of approver non-administrator 116. Additionally, the processing device 302 can transmit the alert 122 to a second plurality of user devices (e.g., user device 110c) associated with a second subset of the plurality of users (e.g., user 108c) with an approval status of approver administrator 118. The processing device 302 may then receive, from a user device of the first plurality of user devices or the second plurality of user devices (e.g., user device 110b or user device 110c), an approval indicator 126. Upon receiving the approval indicator 126, the processing device 302 can automatically transfer the resource 308 from the first user account 120a to the second user account 120b.

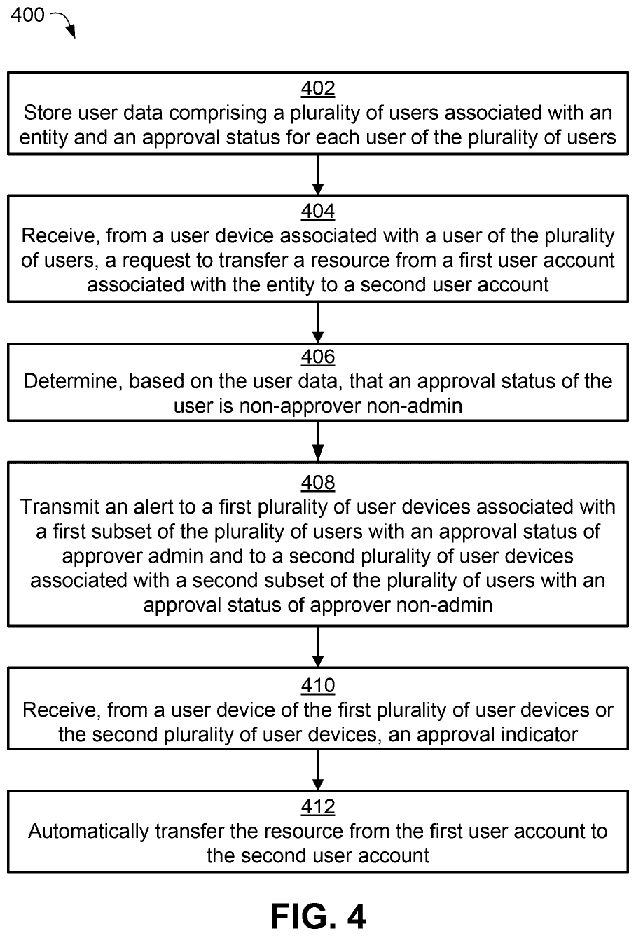

FIG. 4 is a flowchart of an example of a process 400 for implementing an authorization layer to control resource transfers according to some embodiments of the present disclosure. The process 400 can be implemented by the resource management system 102 of FIG. 1 or the computing device 300 of FIG. 3, but other implementations are also possible. While FIG. 4 depicts a certain sequence of steps for illustrative purposes, other examples can involve more steps, fewer steps, different steps, or a different order of the steps depicted in FIG. 4. The steps of FIG. 4 are described below with reference to the components of FIGS. 1-3 described above.

At block 402, the processing device 302 can store user data 106. The user data 106 can include a plurality of users 108a-c associated with an entity and an approval status 112 for each user of the plurality of users 108a-c. The approval status 112 of each of the users 108a-c can be selected from a group including approver administrator 118, approver non-administrator 116, and non-approver non-administrator 114. For example, a first user 108a can have an approval status 112 of non-approver non-administrator 114, a second user 108b can have an approval status 112 of approver non-administrator 116, and a third user 108c can have an approval status 112 of approver administrator 118.

At block 404, the processing device 302 can receive, from a user device 110a associated with a user 108a of the plurality of users 108a-c, a request 124a to transfer a resource 308 from a first user account 120a associated with the entity to a second user account 120b. In an example, the entity can be a corporation and the first user account 120a can be a checking account belonging to the corporation. The request 124a can therefore be a request to transfer financial data (e.g., funds) from the first user account 120a to the second user account 120b. The request 124a can further specify that the financial data be transferred via a resource system 128 (e.g., automated clearing house).

At block 406, the processing device 302 can determine, based on the user data 106, that an approval status 112 of the user 108a is non-approver non-administrator 114. In the example, the processing device 302 may access a database with the user data 106 to determine the approval status 112 of the user 108a. Due to the approval status 112 being non-approver non-administrator 114, the user 108a can transmit the request 124a to transfer the resource 308 via the user device 110a. But, the user 108a may not be able to initiate a transfer of the resource 308 via the resource system 128.

At block 408, the processing device 302 can transmit an alert 122 to a first plurality of user devices associated with a first subset of the plurality of users 108a-c with an approval status 112 of approver administrator 118 and to a second plurality of user devices associated with a second subset of the plurality of users 108a-c with an approval status 112 of approver non-administrator 116. For example, the processing device 302 can transmit the alert 122 to at least a second user device 110b and a third user device 110c. The second user device 110b can be associated with the second user 106b with the approval status 112 of approver non-administrator 116 and the third user device 110c can be associated with the third user 108c with the approval status 12 of approver administrator 118. The processing device 302 can transfer the alert 122 in response to determining that the approval status 112 of the user 108a is non-approval non-administrator 114.

At block 410, the processing device 302 can receive, from a user device of the first plurality of user devices or the second plurality of user devices, an approval indicator 126. For example, the processing device 302 can receive the approval indicator 126 from the second user device 110b or the third user device 110c. The approval indicator 126 can be transmitted by the second user device 110b or the third user device 110c in response to a user selection of an approval option at the second user device 110b or the third user device 110c. The approval option can be included in the alert 122 transmitted to the user devices 110b-c.

At block 412, the processing device 302 can automatically transfer the resource 308 from the first user account 120a to the second user account 120b. The processing device 302 can transfer the resource 308 upon receiving the approval indicator 126. The processing device 302 can transfer the resource 308 by forwarding the request 124a to the resource system 128. The transfer of the resource 308 can then be performed through the resource system 128. For example, a transfer of financial data can be performed through ACH.

In one example, the processing device 302 can store user data 106. The user data 106 can include a mapping that relates each user of a group of users associated with an entity to an approval status. For example, each user can be related, via the mapping, to an approval status of approver administrator, approver non-administrator, or non-approver non-administrator. The processing device 302 can then provide remote access to each of the users to a user account via a software application or web interface executing on a user device associated with each user. The user account can store financial data (e.g., funds, transaction data, or the like) associated with the entity. The users can be provided the remote access due to the user devices associated with each user being registered with the user account. The processing device 302 can then receive, from a user device associated with a user of the group of users, a request to transfer financial data from the user account associated with the entity to another user account of associated with an employee of the entity via a digital payment system. Upon receiving the request, the processing device 302 can access the mapping to determine that an approval status of the user is non-approver non-administrator. In response to determining that the approval status of the user is non-approver non-administrator, the processing device 302 can automatically generate an alert containing information about the request (e.g., an amount or type of data being requested, the user account to which data may be transmitted, the employee the user account belongs too, etc.). The processing device 302 can transmit the alert to user devices associated with a first subset of the group of users with an approval status of approver administrator and associated with a second subset of the group of users with an approval status of approver non-administrator. The processing device 302 can transmit the alert in real time to facilitate efficient approval or denial of the request. The processing device 202 can then receive, from one or more of the user devices associated with the first or second subsets of the group of users, an approval indicator. Receiving the approval indicator can cause the processing device 302 to automatically initiate the transfer of financial data from the user account associated with the entity to the account of the employee via the digital payment system.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
a processing device; and
a memory device that includes instructions executable by the processing device for causing the processing device to perform operations comprising:
receiving user data, the user data comprising a plurality of users associated with an entity and at least one approval status of each user of the plurality of users, wherein the at least one approval status of each user of the plurality of users is selected from a group consisting of approver administrator, approver non-administrator, and non-approver non-administrator; and
generating a graphical user interface based on the user data, wherein the graphical user interface comprises a plurality of user listings and corresponding approval status identifiers, wherein each user listing of the plurality of user listings corresponds to a user of the plurality of users, and wherein the corresponding approval status identifiers indicate the at least one approval status of each user of the plurality of users.

2. The system of claim 1, wherein the at least one approval status for each user of the plurality of users is associated with a resource system, and wherein the graphical user interface further comprises resource system options that are associated with the approval status identifiers.

3. The system of claim 2, wherein each approval status identifier is positionable in the graphical user interface in a first position or in a second position, wherein the first position is associated with an approval status of approval administration or approver non-administrator, and wherein the second position is associated with an approval status of non-approver non-administrator.

4. The system of claim 1, wherein the operations further comprise:
detecting an update to an approval status of a user of the plurality of users based on a user selection of an approval status identifier associated with the user at the graphical user interface; and
updating the user data based on the update to the approval status.

5. The system of claim 1, wherein the operation of generating the graphical user interface comprises loading a first subset of the plurality of user listings and corresponding approval status identifiers at a first time and loading a second subset of the plurality of user listings and corresponding approval status identifiers at a second time.

6. The system of claim 1, wherein the operations further comprise:
receiving, from a user device associated with a user of the plurality of users, a request to transfer a resource from a first user account associated with the entity to a second user account;
determining, based on the user data, that an approval status of the user is non-approver non-administrator;
in response to determining that the approval status of the user is non-approver non-administrator, transmitting an alert to a first plurality of user devices associated with a first subset of the plurality of users with an approval status of approver administrator and transmitting the alert to a second plurality of user devices associated with a second subset of the plurality of users with an approval status of approver non-administrator;
receiving, from a user device of the first plurality of user devices or the second plurality of user devices, an approval indicator; and
upon receiving the approval indicator, automatically transferring the resource from the first user account to the second user account.

7. The system of claim 1, wherein the operations further comprise:
receiving, from a user device associated with a user of the plurality of users, a request to transfer a resource from a first user account associated with the entity to a second user account;
determining, based on the user data, that an approval status of the user is approver non-administrator;
in response to determining the approval status of the user is approver non-administrator, transmitting an alert to a first plurality of user devices associated with a first subset of the plurality of users with an approval status of approver administrator;
receiving, from a user device of the first plurality of user devices, an approval indicator; and
upon receiving the approval indicator, automatically transferring the resource from the first user account to the second user account.

8. The system of claim 1, wherein the operations further comprise:
receiving, from a user device associated with a user of the plurality of users, a request to transfer a resource from a first user account associated with the entity to a second user account;
determining, based on the user data, that an approval status of the user is approver administrator; and
in response to determining the approval status of the user is approver administrator, automatically transferring the resource from the first user account to the second user account.

9. A computer-implemented method comprising:
receiving user data, the user data comprising a plurality of users associated with an entity and at least one approval status of each user of the plurality of users, wherein the at least one approval status of each user of the plurality of users is selected from a group consisting of approver administrator, approver non-administrator, and non-approver non-administrator; and
generating a graphical user interface based on the user data, wherein the graphical user interface comprises a plurality of user listings and corresponding approval status identifiers, wherein each user listing of the plurality of user listings corresponds to a user of the plurality of users, and wherein the corresponding approval status identifiers indicate the at least one approval status of each user of the plurality of users.

10. The computer-implemented method of claim 9, wherein the at least one approval status for each user of the plurality of users is associated with a resource system, and wherein the graphical user interface further comprises resource system options that are associated with the approval status identifiers.

11. The computer-implemented method of claim 10, wherein each approval status identifier is positionable in the graphical user interface in a first position or in a second position, wherein the first position is associated with an approval status of approval administration or approver non-administrator, and wherein the second position is associated with an approval status of non-approver non-administrator.

12. The computer-implemented method of claim 9, further comprising:
detecting an update to an approval status of a user of the plurality of users based on a user selection of an approval status identifier associated with the user at the graphical user interface; and
updating the user data based on the update to the approval status.

13. The computer-implemented method of claim 9, wherein generating the graphical user interface comprises loading a first subset of the plurality of user listings and corresponding approval status identifiers at a first time and loading a second subset of the plurality of user listings and corresponding approval status identifiers at a second time.

14. The computer-implemented method of claim 9, further comprising:
receiving, from a user device associated with a user of the plurality of users, a request to transfer a resource from a first user account associated with the entity to a second user account;
determining, based on the user data, that an approval status of the user is non-approver non-administrator;
in response to determining that the approval status of the user is non-approver non-administrator, transmitting an alert to a first plurality of user devices associated with a first subset of the plurality of users with an approval status of approver administrator and transmitting the alert to a second plurality of user devices associated with a second subset of the plurality of users with an approval status of approver non-administrator;
receiving, from a user device of the first plurality of user devices or the second plurality of user devices, an approval indicator; and
upon receiving the approval indicator, automatically transferring the resource from the first user account to the second user account.

15. The computer-implemented method of claim 9, further comprising:
receiving, from a user device associated with a user of the plurality of users, a request to transfer a resource from a first user account associated with the entity to a second user account;
determining, based on the user data, that an approval status of the user is approver non-administrator;
in response to determining the approval status of the user is approver non-administrator, transmitting an alert to a first plurality of user devices associated with a first subset of the plurality of users with an approval status of approver administrator;
receiving, from a user device of the first plurality of user devices, an approval indicator; and
upon receiving the approval indicator, automatically transferring the resource from the first user account to the second user account.

16. A non-transitory computer-readable medium comprising instructions that are executable by a processing device for causing the processing device to perform operations comprising:
receiving user data, the user data comprising a plurality of users associated with an entity and at least one approval status of each user of the plurality of users, wherein the at least one approval status of each user of the plurality of users is selected from a group consisting of approver administrator, approver non-administrator, and non-approver non-administrator; and
generating a graphical user interface based on the user data, wherein the graphical user interface comprises a plurality of user listings and corresponding approval status identifiers, wherein each user listing of the plurality of user listings corresponds to a user of the plurality of users, and wherein the corresponding approval status identifiers indicate the at least one approval status of each user of the plurality of users.

17. The non-transitory computer-readable medium of claim 16, wherein the at least one approval status for each user of the plurality of users is associated with a resource system, and wherein the graphical user interface further comprises resource system options that are associated with the approval status identifiers.

18. The non-transitory computer-readable medium of claim 17, wherein each approval status identifier is positionable in the graphical user interface in a first position or in a second position, wherein the first position is associated with an approval status of approval administration or approver non-administrator, and wherein the second position is associated with an approval status of non-approver non-administrator.

19. The non-transitory computer-readable medium of claim 16, wherein the operations further comprise:
detecting an update to an approval status of a user of the plurality of users based on a user selection of an approval status identifier associated with the user at the graphical user interface; and
updating the user data based on the update to the approval status.

20. The non-transitory computer-readable medium of claim 16, wherein the operation of generating the graphical user interface comprises loading a first subset of the plurality of user listings and corresponding approval status identifiers at a first time and loading a second subset of the plurality of user listings and corresponding approval status identifiers at a second time.
